(19) United States
(12) Patent Application Publication
(10) Pub. No.: US 2006/0039637 A1
(43) Pub. Date: Feb. 23, 2006

(54) Dynamic pressure bearing device

(76) Inventor: Shu-Chin Huang, Taoyuan (TW)

Correspondence Address: BACON & THOMAS, PLLC, 625 SLATERS LANE, FOURTH FLOOR, ALEXANDRIA, VA, 22314, US

(21) Appl. No.: 10/921,969

(22) Filed: Aug. 20, 2004

(51) Int. Cl. F16C 32/06

(52) U.S. Cl. 384/114

(57) ABSTRACT

The present invention discloses a dynamic pressure bearing device, comprising a bearing, an axial hole passing through the bearing, a plurality of dynamic pressure generating grooves extended along the axial direction and disposed on the periphery of the axial hole. The dynamic pressure generating groove comprises a fluid lubricating medium therein, and these dynamic pressure generating grooves comprise a base section extended along the axial direction, and a lateral section is expanded and extended from both ends of the base section, and these lateral sections are curved in shape, such that when the axle center rotates in the bearing, the fluid lubricating medium originally disposed at the lateral section will flow towards the base section and concentrate at the base section to have a slightly protruded shape as to press against the axle center for rotating the axle center stably. Since the lateral section is curved in shape, therefore the lubricating medium therein will flow into the base section completely without staying on the lateral section. Therefore, the air in the bearing will pass through the bearing successfully without staying on the bearing or producing noised.

### BACKGROUND OF THE INVENTION

1. Field of the Invention

The present invention relates to a dynamic pressure bearing device, more particularly to a bearing device comprising a plurality of curved dynamic pressure generating grooves being extended along the axial directions and disposed on the internal wall of the bearing, so that a lubricating medium can flow smoothly and the air will not remain in the lubricating medium as to prevent producing noises.

2. Description of the Related Art

A bearing is a device generally being applied to a rotary mechanical part and used for supporting, reducing friction and bearing loads; for example, a bearing is used in an axle motor. As the science and technology advance, the components are getting smaller and more precise, and thus the demand for the precision of a bearing is getting higher and higher. In general, a ball bearing is the common one that usually demands a high precision. However, there exist some problems including noises, insufficient precision of the rotation, high cost for miniaturization and incompliance with the requirements for miniaturization and precision.

To meet the requirements above and reduce the rotary friction, fluid bearings are presented to the public. The fluid bearing not only has a high precision, but also features a low noise and an excellent shock resistance. The fluid bearing is generally divided into two types: a static pressure fluid bearing and a dynamic pressure fluid bearing. The static pressure fluid bearing has the fluid lubricating medium inside the bearing under normal conditions, and the pressure of the fluid supports the axle center when the bearing rotates. If the axle center shifts, then the shifted side is pressurized as to resume the correct position of the axle center. Since the static pressure bearing always has a large quantity of fluid lubricating medium inside the bearing in normal conditions, therefore the static pressure bearing is not applicable for the general rotary mechanical parts that require a high compactness and a high precision. On the other hand, a dynamic pressure bearing has tiny grooves inside the bearing hole, and the grooves has a lubricating medium inside the grooves (Since the groove is tiny, therefore the quantity of the lubricating medium is very little). When the axle center rotates, the lubricating medium inside the groove will be driven to produce a dynamic pressure to support the axle center in the central position.

Please refer to FIG. 1 for a dynamic pressure bearing being applied to the motor of a fan. The motor has a motor base 100, and the motor base 100 has an upwardly extended bearing cover 110 and the bearing cover 110 mounts a bearing 120. Please refer to FIG. 2. The bearing 120 has an axial hole 121 and the axial hole 121 has a plurality of dynamic pressure generating grooves 122 disposed on the wall of the periphery of the axial hole 121 and aligned in a fish bone like pattern and extended along the radial direction. The dynamic pressure generating grooves 122 are inwardly tapered from both ends into a T shape, and a plurality of circular escape holes 123 is disposed around the periphery of the axial hole 121 among these dynamic pressure generating grooves, and a motor rotor 130 is disposed at the periphery of the bearing cover 110, and a motor rotor 140 is installed on the motor rotor 130.

The motor rotor 140 comprises a fan vane 141 at the periphery of the motor rotor 140. Further, the motor rotor 140 comprises an axle center 143 passing through the axial hole 121 and a magnet 142 corresponding to the motor rotor 130. When the structure of this device is in use, the dynamic pressure generating groove 122 produces a drag to the lubricating medium in the axial hole 121 as to produce the dynamic pressure, and the axle center 143 is supported at the central position. However, when the axle center 143 is started, the pressure has not been established yet due to the dynamic pressure, and thus will cause an abrasion.

Further, since the dynamic pressure generating groove 122 with both sides being extended outwardly and having a straight and flat shape, such that the lubricating medium is blocked by the vertical tangential edges of the dynamic pressure generating grooves 122 when flowing inside the dynamic pressure generating grooves 122. The fluid lubricating medium cannot flow into the intersection successfully and a small portion of the lubricating medium remains on both sides of the dynamic pressure generating groove 122. Furthermore, since the dynamic pressure generating grooves only have one intersection point, therefore it is impossible to keep any lubricating medium that flows in, and causes the lubricating medium to flow away.

### SUMMARY OF THE INVENTION

In view of the difficulty for the implementation and manufacture of the dynamic pressure bearing according to the prior art, the inventor of the present invention focused on the problems to start finding a way for the improvement and overcome the shortcomings in hope of finding a feasible solution, and conducted extensive researches and experiments and finally invented the dynamic pressure bearing device in accordance with the present invention.

Therefore it is the primary objective of the present invention to provide a dynamic pressure bearing device that can be applied onto a rotary mechanic part for supporting, reducing the friction and bearing the load, such as the one being applied to a motor axle of a heat dissipating fan. Such device comprises a bearing, and the bearing comprises an axial hole passing through the bearing, and the axial hole at its periphery comprises a plurality of dynamic pressure generating grooves orderly aligned and extended along the axial direction. The dynamic pressure generating groove contains a fluid lubricating medium and a base extended along the axial direction. A lateral section outwardly expanded and extended from both ends of the base and the lateral sections are in a curved shape, so that when the axle center rotates in the bearing, the fluid contained inside the dynamic pressure generating groove flows from the lateral section to the base section and concentrate at the base section and have a slightly protruded shape to press on the axle center and steadily rotate the axle center. Since the lateral section is curved in shape, therefore the lubricating medium inside will not be blocked. All of the lubricating medium will flow into the base section and will not remain on the lateral section, so that the air in the bearing will not blocked by the lubricating medium but will pass the bearing without staying on the bearing, and thus can prevent producing noises.

Another objective of the present invention is to provide a dynamic pressure generating device, and the length of the base of the dynamic pressure generating device depends on the viscosity of the lubricating medium.

A further objective of the present invention is to provide a dynamic pressure generating device, and a circular escape hole is extended in the radial direction and disposed on a specific portion of the plane, and the escape hole can divide the interior of the bearing into two or more sections.

### BRIEF DESCRIPTION OF THE DRAWINGS

The above objects, features and advantages of the present invention will become apparent from the following detailed description taken with the accompanying drawing. However, these drawings are provided for reference and illustration and not intended to act as a limitation to the present invention.

FIG. 1 is a cross-sectional view of the dynamic pressure bearing device according to a prior art.

FIG. 2 is a cross-sectional view of a bearing of the dynamic pressure bearing device according to a prior art.

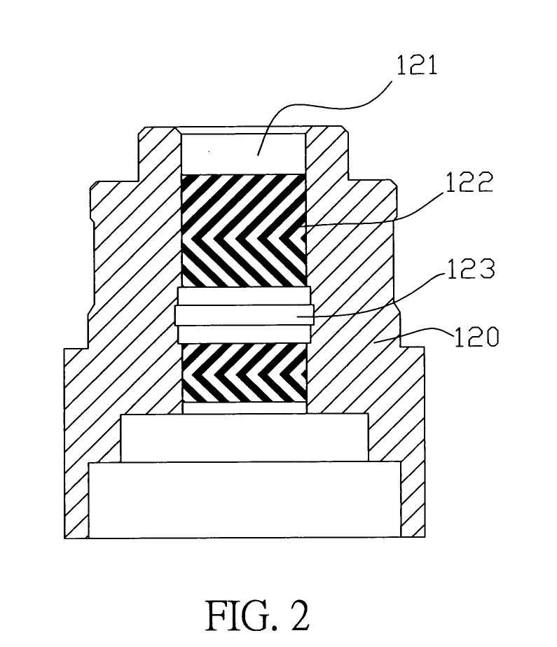

FIG. 3 is a perspective view of a bearing of the dynamic pressure bearing device according to the present invention.

FIG. 4 is a cross-sectional view of a bearing of the dynamic pressure bearing device according to a preferred embodiment of the present invention.

FIG. 4A is another cross-sectional view of a bearing of the dynamic pressure bearing device according to a preferred embodiment of the present invention.

FIG. 5 is a cross-sectional view of the dynamic pressure generating groove of a bearing of the dynamic pressure bearing device according to a preferred embodiment of the present invention.

FIG. 6 is a cross-sectional view of the bearing according to another preferred embodiment of the present invention.

### DETAILED DESCRIPTION OF THE PREFERRED EMBODIMENTS

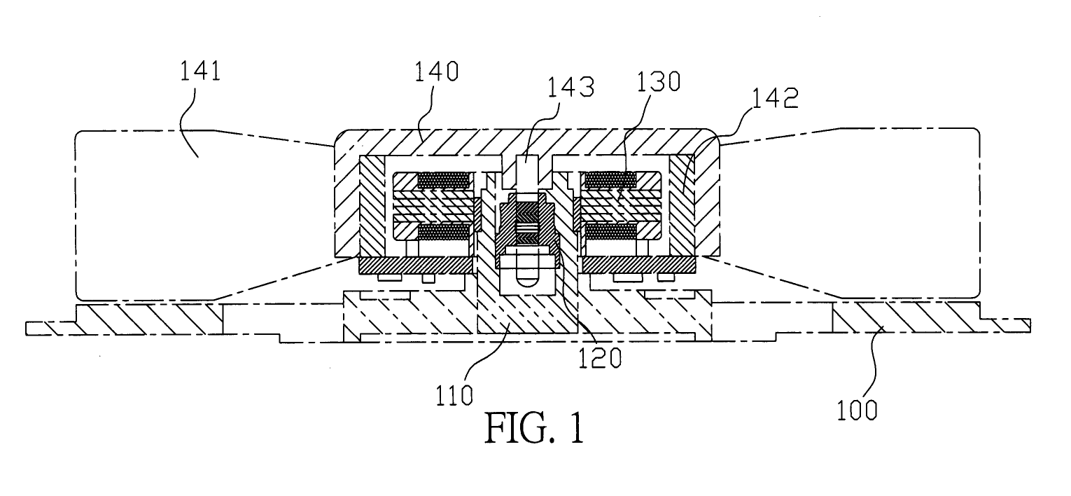

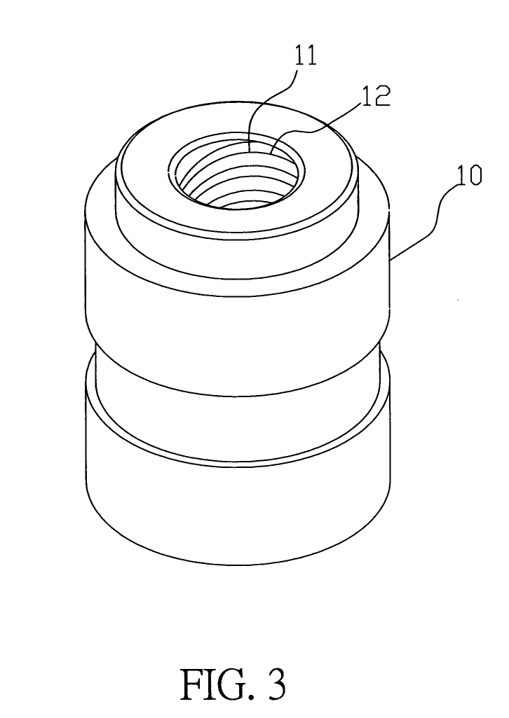

Please refer to FIGS. 3 to 6 for a dynamic pressure bearing device of the present invention. The dynamic pressure device is used on a rotary mechanical part for supporting, reducing the pressure and bearing the load, such as being used in a fan motor as shown in FIG. 1. The motor comprises a motor base 100, and a bearing cover 110 upwardly extended from the motor base 100, a motor stator 130 disposed at the periphery of the bearing cover 110, a motor rotor 140 disposed on the motor stator 130 and a vane 141 disposed on the periphery of the motor rotor 140. Further, the motor rotor 140 comprises an axle center 143 and a magnet 142 corresponding to the motor stator 130.

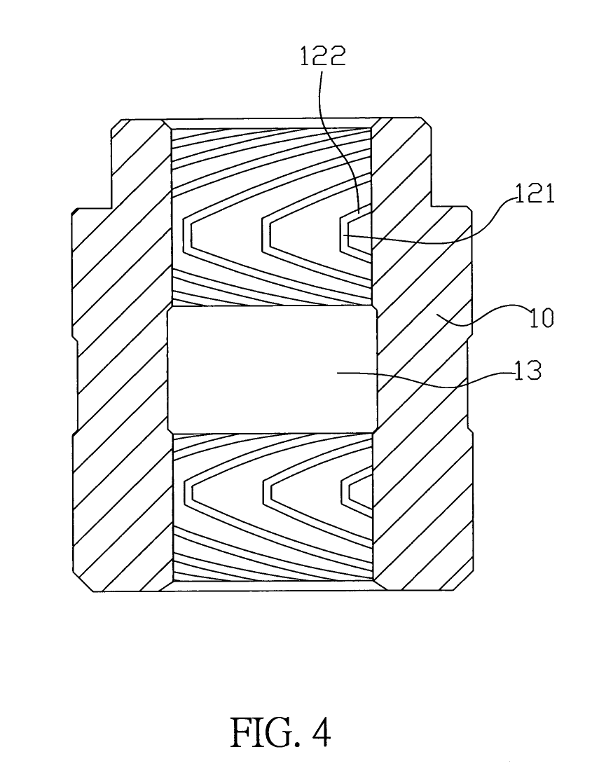

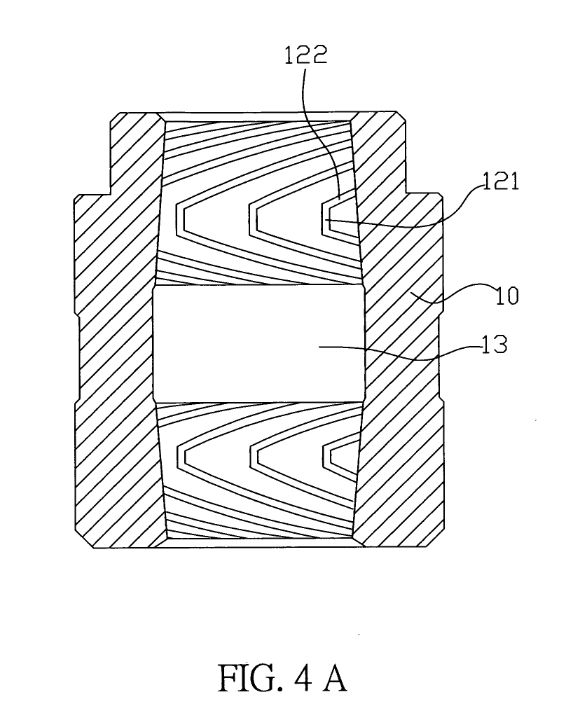

Further, a bearing 10 passes into the axle cover 110; a penetrating axial hole 11 is disposed on the bearing 10; and the axial hole 11 is in a barrel shape tapered from its center to both sides (as shown in FIG. 4A) to produce a certain slope.

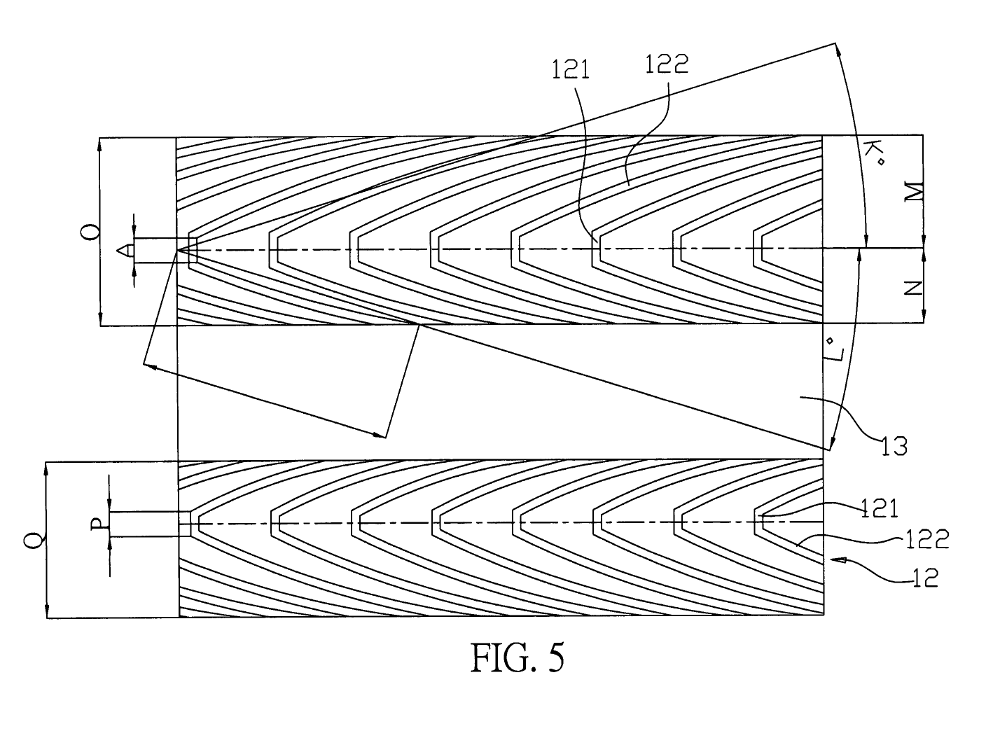

The axial hole 11 comprises a plurality of dynamic pressure generating grooves 12 orderly disposed and extended along the axial and radial directions, and these dynamic pressure generating grooves 12 contain a fluid lubricating medium (not shown in the figure). Please refer to FIGS. 4 and 5. The dynamic pressure generating grooves 12 individually comprise a base section 121 extended along the axial direction which are marked as A and P as shown in FIG. 5, and the length of these base sections 121 is adjusted according to the viscosity of the fluid lubricating medium. A lateral section 122 is outwardly extended from both ends of the base section 121 and a specific included angle exists between the lateral section 122 and the base section 121 which are labeled as K and L in this embodiment, and the included angle between K and L is smaller than 90 degrees. The lateral section 122 is curved in shape, such that when the axle center 10 rotates in the bearing 10, the fluid contained in the dynamic pressure generating groove 12 is dragged by the centrifugal force to flow from the lateral section 122 to the base section 121 and concentrate at the base section 121 and have a slightly protruded shape as to press on the axle center 143, so that the axle center 143 can rotate stably. Since the lateral section 122 is curved in shape, therefore the lubricating medium will not be blocked and all of the lubricating medium flow into the base section 121 without staying on the lateral section 122. The air in the bearing will not be blocked by the lubricating medium, but will pass through the bearing 10 successfully without staying on the bearing 10. Therefore, the pressure of the fluid flowing into each lateral section 121 due to its rotation will be even and the axle center 143 will not be tilted to produce a friction with the bearing 10, and thus will not produce noises. Further, when the fluid is flowing in the dynamic pressure generating grooves 12, the flowing fluid is blocked by the curved axial hole 11 as to prevent the fluid from being spilt from both ends of the axial hole easily.

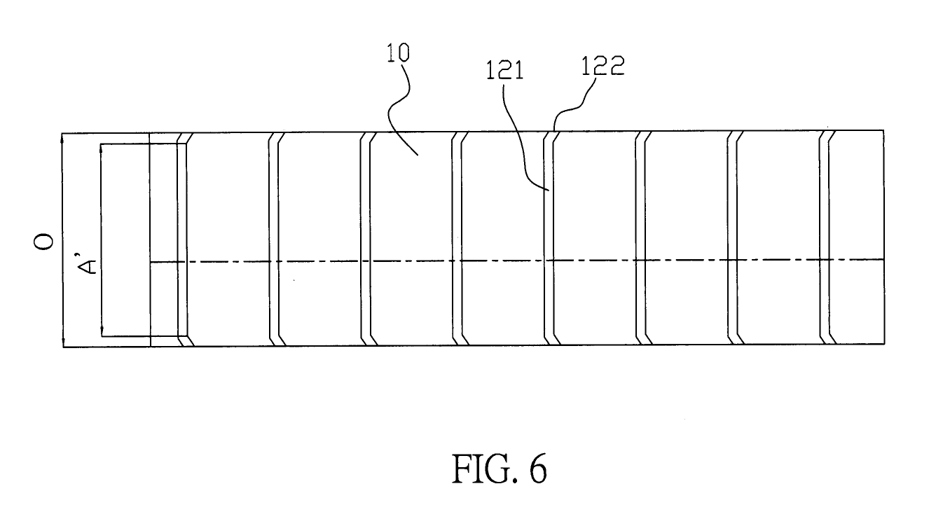

Please refer to FIGS. 4 and 5. A circular escape hole 13 is extended in the radial direction along the axial hole 11 and disposed on the periphery of the axial hole 11 and the escape hole 13 can divide the dynamic pressure generating grooves 12 into two or more sections. Furthermore, the base section 121 of the dynamic pressure generating groove 12 can be extended from both sides to the lateral section 122 and the base section 121 can be reduced to a very short length (as labeled as A′ in FIG. 6).

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A dynamic pressure bearing device, comprising:
a bearing,
an axial hole, penetrating said bearing;
a plurality of dynamic pressure generating grooves, being extended along an axial direction and orderly disposed on the periphery of said axle hole and said dynamic pressure generating groove comprising a base disposed along the axial direction and said dynamic pressure groove containing a fluid lubricating medium therein and said dynamic pressure generating groove having a base section extended along an axial direction and a lateral section being outwardly expanded and extended laterally from said base section and said lateral section being in a curved shape, thereby when said axle center rotating in said bearing, said fluid lubricating medium originally stayed on said lateral side flowing towards said base section and concentrating on said base to form a slightly protruded shape and pressing on said axle center as to rotate said axle center stably, and since the lateral section being in a curved shape, therefore all of said fluid lubricating medium flowing into the base section as to pass the air in said bearing through said bearing successfully without staying on said bearing and making the pressure of said fluid lubricating medium to flow into each of said base sections even and preventing said axle center from being tilted and producing friction to said bearing and thus preventing said bearing from producing noises.

2. The dynamic pressure bearing device of claim 1, wherein said dynamic pressure generating groove and said base section have an included angle not exceeding 90 degrees.

3. The dynamic pressure bearing device of claim 1, wherein said base section of said dynamic pressure generating groove has a length adjustable according to the viscosity of said fluid lubricating medium.

4. The dynamic pressure bearing device of claim 1, wherein said axial hole comprises a circular escape hole disposed on the periphery of said axial hole and extended along its axial direction, and said escape hole divides said dynamic pressure grooves into at least two sections.

5. The dynamic pressure bearing device of claim 1, wherein said axial hole is tapered from its center towards both ends.
